(19) United States
(12) Patent Application Publication
(10) Pub. No.: US 2012/0299963 A1
(43) Pub. Date: Nov. 29, 2012

(54) METHOD AND SYSTEM FOR SELECTION OF HOME FIXTURES

(76) Inventors: Kenneth M. Wegrzyn, Sylvania, OH (US); Paul M. Best, Toledo, OH (US)

(21) Appl. No.: 13/479,400

(22) Filed: May 24, 2012

Related U.S. Application Data
(60) Provisional application No. 61/491,043, filed on May 27, 2011.

(51) Int. Cl. G09G 5/377; G06F 3/041; G06F 3/01

(52) U.S. Cl. 345/633; 345/156; 345/173

(57) ABSTRACT

A system for selecting one of a plurality of home fixtures, includes a processor, a memory including a database, an input device, and a display. The processor executes instructions to present information corresponding to the home fixtures. The memory is in communication with the processor. The database contains the information corresponding to the home fixtures, such as materials, models, category, accessories, 360° views, high definition images and specifications. The database also contains information corresponding to a context, such as a counter top surface, that may be associated with the home fixtures. The input device permits a user to select the one of the home fixtures to be presented. The display is in communication with the processor, and is configured to show the information corresponding to the home fixtures. The system may also include a camera that permits acquisition of information corresponding to a custom context for the home fixture.

### CROSS-REFERENCE TO RELATED APPLICATIONS

This application claims the benefit of U.S. Patent Application No. 61/491,043 filed on May 27, 2011. The entire disclosure of the above application is hereby incorporated herein by reference.

### FIELD OF THE INVENTION

The present disclosure relates to methods and systems for selecting home fixtures and, in particular, a method and a system for displaying a home fixture within a customized context for the purpose of selecting the home fixture.

### BACKGROUND OF THE INVENTION

Retail sales of home improvement products, including home fixtures such as sinks, faucets, and related accessories, are known to have an enormous square footage requirement. Typically, in order for a retailer to display the many styles, colors, and accessories for home fixtures that are available to customers, a considerable amount of building space is required. It has been heretofore impractical to provide the customers with an opportunity to shop the retailer's complete inventory.

There is a continuing need for a system and method for enabling customers to view selected home fixtures, such as sinks and related accessories, from a retailer's inventory on a display, and in which data describing the inventory is automatically updated to reflect current inventory availability. Desirably, the system and method may be practiced on-site at the retailer's location or on a mobile device of a consumer, and permits the consumer to personalize a context within which the selected home fixtures are viewed.

### SUMMARY OF THE INVENTION

In concordance with the instant disclosure, a system and method for enabling customers to view selected home fixtures such as sinks and accessories from a retailer's inventory on a display, in which data describing the inventory is automatically updated to reflect current inventory availability, which may be practiced on-site at retail locations or on a mobile device of a consumer, and which permits the consumer to personalize a context within which the selected home fixtures are viewed, is surprisingly discovered.

In one embodiment, a system for selecting one of a plurality of home fixtures includes a processor, a memory having at least one database, an input device, and a display. The processor executes instructions to present information corresponding to the home fixtures such as sinks. The memory is in communication with the processor. The at least one database also includes information corresponding to a context such as a counter top surface that may be associated with the home fixtures. The input device is in communication with the processor, and permits a user to select the one of the home fixtures to be presented. The display is in communication with the processor, and is configured for showing the information corresponding to the home fixtures.

In a further embodiment, a method for selecting one of a plurality of home fixtures includes a step of storing in a database of a memory information corresponding to home fixtures and information corresponding to a context that may be associated with the home fixtures. A screen is generated on a display for showing the information corresponding to the home fixtures and the information corresponding to the context that may be associated with the home fixtures. The one of the plurality of home fixtures is selected based upon information provided by the user through an input device. The information corresponding to the selected home fixture is shown on the screen.

In another embodiment, a method for selecting one of a plurality of home fixtures includes a step of storing in a database of a memory information corresponding to home fixtures and information corresponding to a context that may be associated with the home fixtures. A screen is generated on a display for showing the information corresponding to the home fixtures and the information corresponding to the context that may be associated with the home fixtures. The one of the plurality of home fixtures is selected based upon inputs provided by the user through an input device. The information corresponding to the context that may be associated with the home fixtures is acquired with a camera. The selected context is then associated with the selected home fixtures. In real-time, the information corresponding to the selected home fixture and the information corresponding to the context is shown on the screen of the display. The selected home fixture may thereby be viewed by the user in the selected context.

### DRAWINGS

The above, as well as other advantages of the present disclosure, will become readily apparent to those skilled in the art from the following detailed description, particularly when considered in the light of the drawings described hereafter.

FIG. 1 is a schematic block diagram of a system for selecting one of a plurality of home fixtures, in accordance with the present disclosure;

FIG. 2 is a flow diagram of a method of operation of the system shown in FIG. 1, in accordance with one embodiment of the present disclosure;

FIG. 3 is a front elevational view of the system shown in FIG. 1, provided as a stand alone kiosk;

FIG. 4 is a fragmentary front elevational view of the stand alone kiosk shown in FIG. 3, showing an illustrative screen shot of a display illustrating options for reviewing specifications, accessories, high definition images, 360° views, counter tops, and saving selections to a list, and further showing a home fixture without a context;

FIG. 5 is an illustration of a user providing a sample of a context, in which the home fixture is to be disposed, for acquisition by a camera of the stand alone kiosk shown in FIG. 3;

FIG. 6 is a fragmentary front elevational view of the stand alone kiosk shown in FIG. 3, showing the illustrative screen shot of the display, and further showing the home fixture in a context selected by the user;

FIG. 7 is a flow diagram of a method of operation of the system shown in FIG. 1, in accordance with another embodiment of the present disclosure;

FIG. 8 is a front elevational view of the system shown in FIG. 1, provided as a handheld mobile device;

FIG. 9 is a rear elevational view of the system shown in FIG. 8, and further showing a camera of the handheld mobile device;

FIG. 10 is a perspective view of a desired location for a selected home fixture, shown with a pre-existing home fixture positioned at the desired location;

FIG. 11 is a perspective view of the desired location for the selected home fixture shown in FIG. 10, with a sensory target disposed on the pre-existing home fixture; and

FIG. 12 is a perspective view of the desired location for the selected home fixture, shown through the handheld mobile device of FIG. 9, with the selected home fixture replacing the pre-existing home fixture on the handheld mobile device, in real-time.

### DETAILED DESCRIPTION OF THE INVENTION

The following description is merely exemplary in nature and is not intended to limit the present disclosure, application, or uses. It should also be understood that throughout the drawings, corresponding reference numerals indicate like or corresponding parts and features. In respect of the methods disclosed, the order of the steps presented is exemplary in nature, and thus, is not necessary or critical.

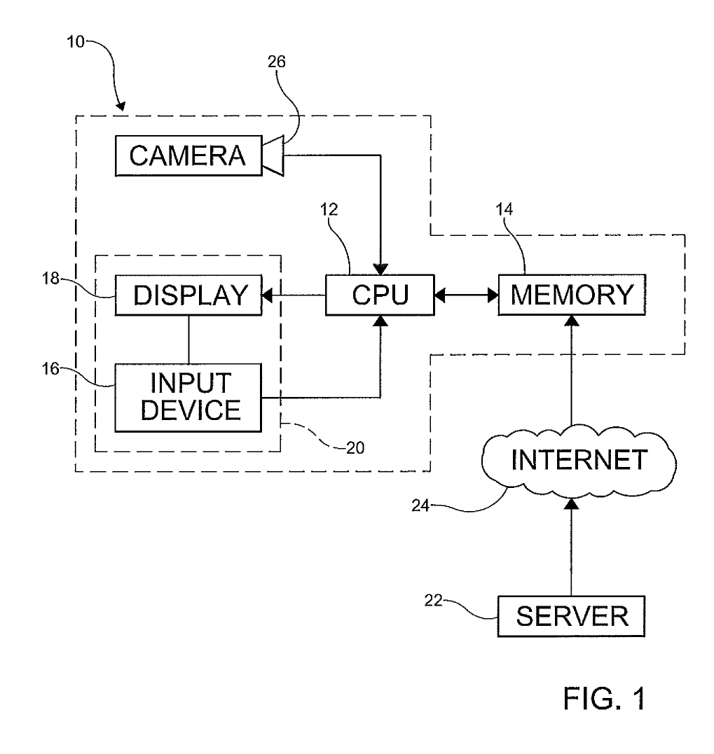

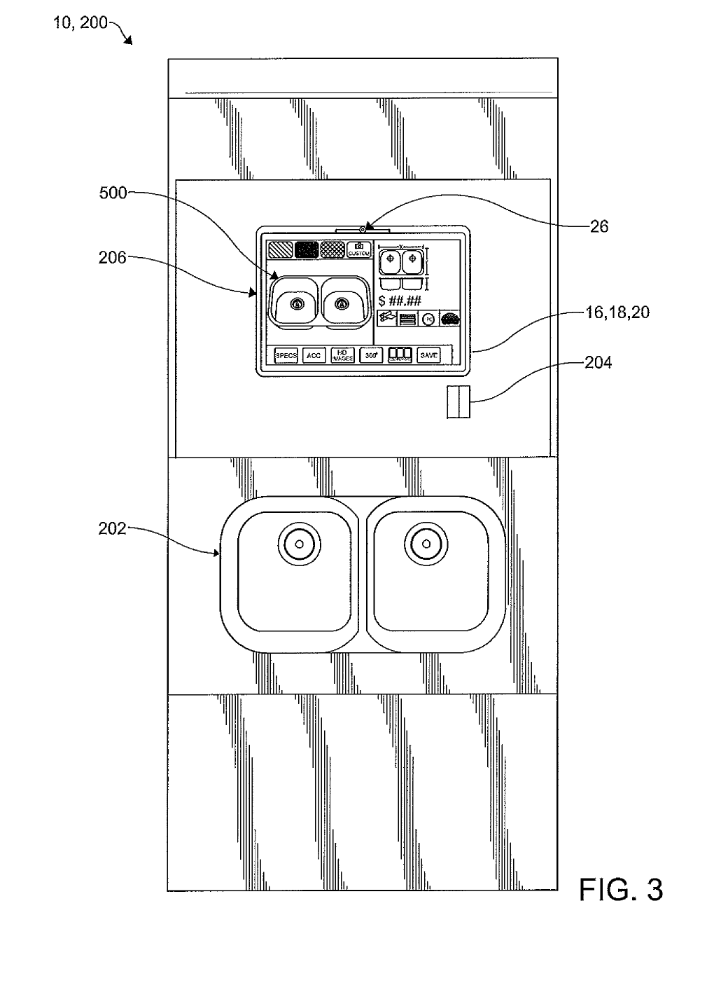

In FIG. 1, a system 10 is shown for selecting one of a plurality of home fixtures 500 (depicted in FIGS. 3-6, 8, and 12). In illustrative embodiments, the home fixtures 500 are sinks and related accessories such as faucets, handles, knobs, etc. One of ordinary skill in the art should understand that other types of home fixtures 500 may also be selected with the system 10 of the disclosure, as desired.

The system 10 includes a processor 12 such as a central processing unit (CPU). The processor 12 may have random access memory (RAM) and run an operating system such as a Linux-based operating system, as a nonlimiting example. Other types of processors 12 and operating systems may also be employed within the scope of the present disclosure.

The processor 12 is configured to execute instructions for presenting information corresponding to the home fixtures 500. The information corresponding to the home fixtures 500 includes, but is not limited to, at least one of materials, models, category, accessories, 360° views, high definition images and specifications. Other information corresponding to the home fixtures 500 may also be presented within the scope of the present disclosure.

A memory 14 is in communication with the processor 12. The memory 14 includes at least one database with the information corresponding to the home fixtures 500. Advantageously, and as described further herein, the at least one database of the memory 14 also includes information corresponding to a context 502 that may be associated with the home fixtures 500. In exemplary embodiments, the context 502 is a surface of a counter top surrounding the home fixtures 500. In other examples, the context 502 may be a desired location for the home fixtures 500, such as a room or space of a household in which the home fixtures 500 may be installed. Other suitable types of contexts 502 may also be used within the scope of the present disclosure.

The system 10 further includes an input device 16 and a display 18. The input device 16 is in communication with the processor 12. The input device 16 permits a user to select the one of the home fixtures 500 to be presented. The display 18 is also in communication with the processor 12. The display 18 is configured to show the information corresponding to the home fixtures 500.

In particular embodiments, the input device 16 and the display 18 are provided together as a single graphical user interface 20. For example, the graphical user interface 20 may be a touch screen display. In other embodiments, the input device 16 may be provided as a physical device such as a keyboard, a mouse, or another instrument separated from the display 18 that permits the user to interact with the system 10. A skilled artisan may select suitable types of the input device 16 and the display 18, as desired.

As further shown in FIG. 1, the system 10 may be in communication with a server 22 via a network connection 24. The network connection 24 may include at least one of an Internet connection and a local area network (LAN) connection. The network connection 24 may be a wired connection or a wireless connection, as desired. The network connection 24 places the system 10 in communication with the server 22. The server 22 is permitted to update the information corresponding to the home fixtures 500 in the database on the memory 14 of the system 10. As such, a screen on the display 18 may be generated locally from the memory 14, without requiring the network connection 24 to be active during operation of the system 10.

The updates to the memory 14 of the system 10 may be automatically conducted on an ongoing or a periodic basis, or may be manually initiated by an action of the user, as desired. The updates may include new information pertaining to inventory, models, accessories, new products and the like. The server 22 may be placed in communication with the system 24 via the network connection 24 using known secure means. For example, an appropriate operating system and associated protocols may be employed for uploading updates in a secure or encrypted manner. In one embodiment, the processor 12 may be running the Linux-based operating system to cause the system 10 to communicate with the server 22 for storage and retrieval of the necessary updates.

Skilled artisans will also recognize that other means of providing updates to the system 10 may also be used. For example, data may be stored and retrieved and transported between databases using available data storage devices such as thumb drives, removable disks, mobile phones and the like.

In another nonlimiting example, the network connection 24 is active during operation of the system 10, and the processor 12 causes a web page to be generated on the display 18. For example, the system 10 may include a PuP server and a MySQL Server, which may be installed locally on the system 10, and which facilitates a PHP code and MySQL database function necessary to query the plurality of home fixtures 500 and related accessories. The PuP code may enable the processor 12 to filter necessary products, and the MySQL server may serve as the memory 14 for storing all information. In one embodiment, the presentation of the screen on the display 18 is based in JavaScript language such as J. Query. Thus, code is validated and propelled via the input device 16, and causes related information to be shown to the user on the screen of the display 18. Other nonlimiting examples of programming language that may be used with the system 10 include HTML, CSS, and PHP.

The system 10 of the present disclosure further includes a camera 26. The camera 26 is in communication with the processor 12. Any suitable type of camera 26 or other visual sensing means for acquiring digital images may be used as the camera 26. In certain embodiments, the camera 26 is used to acquire digital still images. In particular embodiments, the camera 26 is used to acquire digital video images. The digital still images and the digital video images may be stored as information in the memory 14 of the system 10, for later reconstruction as images on screens generated by the processor 12 on the display 18.

Advantageously, and as described further herein, the camera 26 may be used to acquire additional information corresponding to the context 502 that may be associated with the home fixtures 500. For example, the additional information corresponding to the context 502 includes an image of a surface, such as a counter top, in which the home fixture 500 may be disposed. In another example, the additional information corresponding to the context 502 includes an image of a location, such as a kitchen, in which the home fixture 500 may be disposed. Other types of additional information corresponding to the context 502 may also be acquired by the camera 26, as desired.

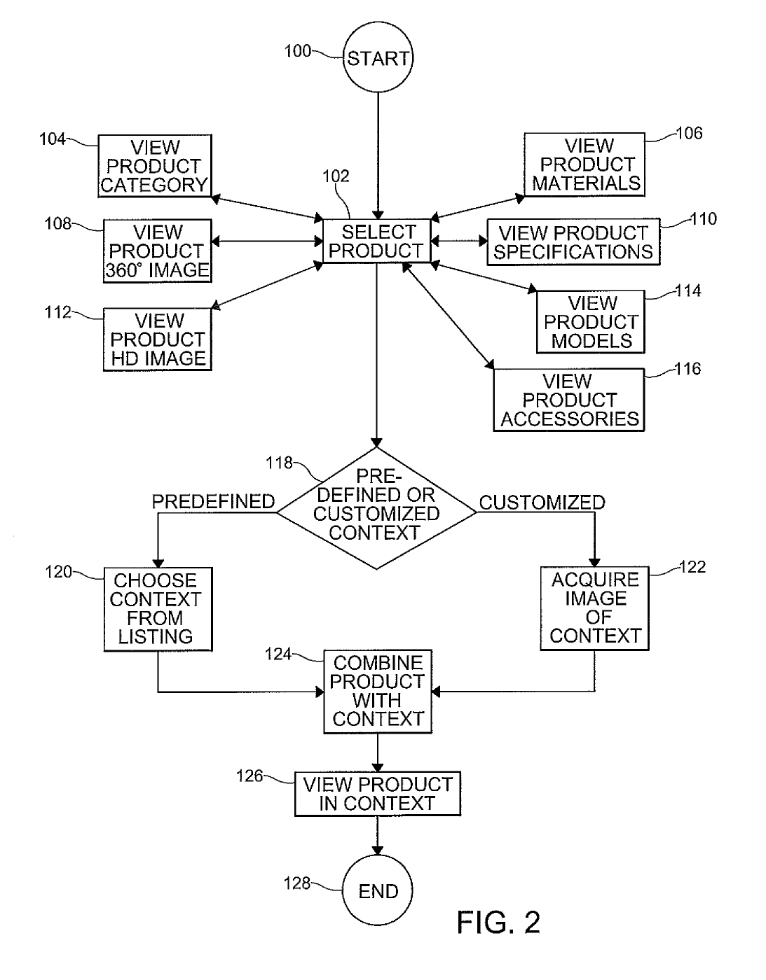

There is shown in FIG. 2 a flow diagram of a method according to the present disclosure, which method can be implemented as a software program residing in the memory 14 and executed based on inputs from the user utilizing the processor 12 of the system 10. The sequence of steps of the method will be initially described, and then an exemplary screen generated during the execution of the method steps will be described in more detail.

The method shown in FIG. 2 begins at circle 100, in which the user is permitted to start a sequence of screens generated on the display 18 for the step 102 of selecting one of the plurality of home fixtures 500. The processor 12 generates the sequence of screens on the display 18. The screens on the display 18 may prompt the user provide inputs as instructions utilizing the input device 16. The inputs are utilized by the processor 12 to select a desirable one of the home fixtures 500. For example, the sequence of screens may include a product category screen 104, a product materials screen 106, a product 360° image screen 108, a product specifications screen 110, a product high definition image screen 112, a product models screen 114, and a product accessories screen 116. The user may navigate to one or more of these screens and select features therefrom using the input device 16, for the purpose of selecting the one of the plurality of home fixtures 500 in the step 102.

Following the step 102 of selecting the home fixture 500, the method includes a decision point 118 in which the user may select the context 502 within which to review the home fixture 500. The user may select either a predefined context 502, for example, from a listing of contexts 502 stored in the memory 14, as shown in step 120, or a customized context 502. With reference to step 122, the customized context 502 may be acquired through use of the camera 26. For example, as depicted in FIG. 5, the user may hold a surface 504 such as a sample of granite counter top in front of the camera 26 for acquisition of an image of the surface 504. Information corresponding to the image of the surface 504 is then stored in the memory 14 of the system 10 as the customized context 502.

Where both the home fixture 500 and the context 502, either predefined or customized, have been selected, a step 124 is performed by the system 10 in which the selected home fixture 500 is combined with the selected context 502. A screen is then generated by processor 12 in a step 126, in which the selected home fixture 500 is shown in the selected context 502. The method then ends, as shown in circle 128, with the user being able to at least one of save the elected home fixture 500 to a list having information corresponding to at least one of the home fixtures 500, make a purchase of the selected home fixture 500, and repeat the method with a different home fixture 500.

In an illustrative embodiment shown in FIGS. 3-6, the system 10 is provided as a stand alone kiosk 200 for selection of the home fixtures 500. The kiosk 200 may be located at a point-of-sale such as on-site at home fixture supply stores or home improvement retail stores, for utilization by customer-users. As illustrated in FIG. 3, the kiosk 200 includes the graphical user interface 20 having the touch screen display 18. A. The kiosk 200 may also include a physical specimen 202 of one of the home fixtures 500 that may be selected, embedded in the kiosk 200 below the graphical user interface 20. Advantageously, the kiosk 200 also has the camera 26, shown disposed above the touch screen display 18 in FIG. 3. Other suitable locations for the camera 26 on the kiosk 200 may also be used.

In certain examples, the kiosk 200 also includes transaction means 204 for completing point-of-sale transactions. Where the transaction means 204 is provided, the selected home fixtures 500 may be ordered from any location such as a home improvement or hardware store by way of the kiosk 200. Various transaction means 204 for completing transactions including cash slots or credit card swiping devices, and software driven means such as an electronic shopping cart or a click-and-purchase system, for example, may also be integral with or, optionally, added to the kiosk 200, as desired. It should be understood that the kiosk 200 may be located in stores where customers can make transactions independently of the subject stores. In such cases, the selected home fixture may subsequently be shipped to a predetermined address inputted into the system 10 by the customer.

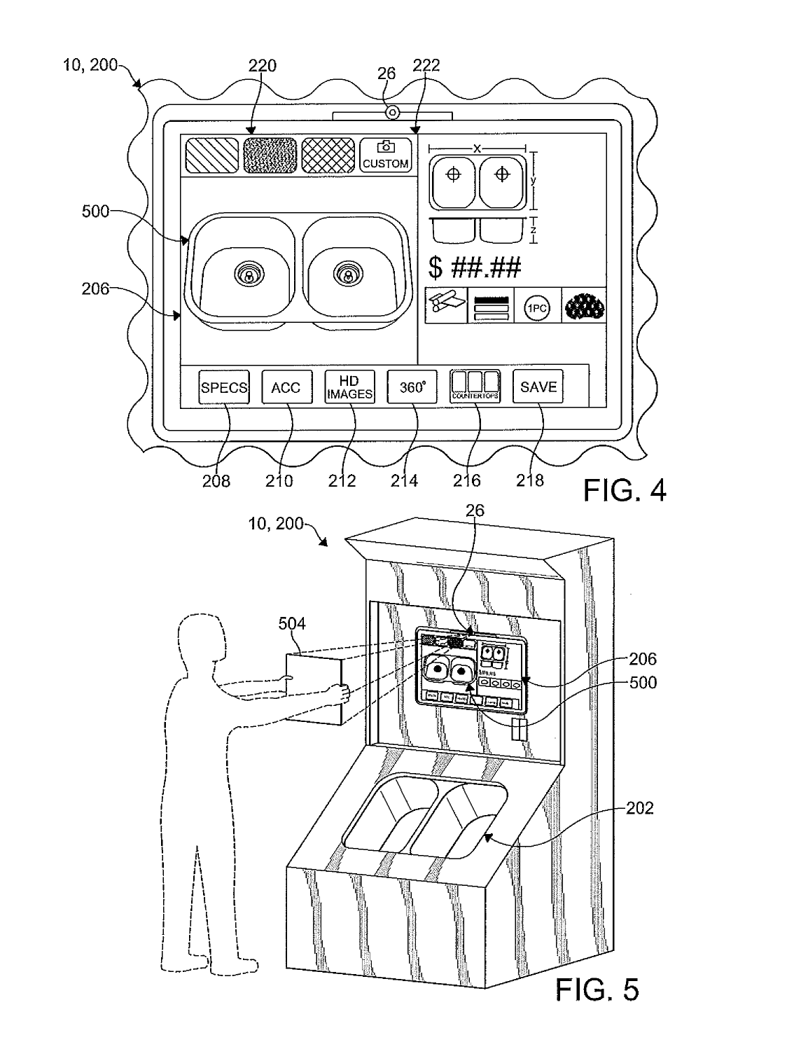

With reference to FIG. 4, an exemplary screen 206 generated by the system 10 on the touch screen display 18 is shown, in a state prior to a combining the selected home fixture 500 with the selected context 502. From a start up screen (not shown), the user selects a start button in the upper left-hand corner. The system 10 then loads all the information corresponding to the home fixtures 500 available.

Navigation buttons, or panels, provided on a screen of the display 18 permit the user to navigate to other screens. The navigation buttons include at least one of a specifications button 208, an accessories button 210, a high definition images button 212, a 360° view button 214, a counter tops button 216, and a save-to-list button 218.

A selecting of the specifications button 208 results in the generation of a screen with specifications relating to the home fixtures 500. For example, a pop-out panel may be loaded with information about the home fixture 500 selected including the dimensions of the home fixture 500, a wire framed view of the home fixture 500, and any specific details pertaining to the home fixture 500. A color selector may also be made available at a bottom of the panel for certain types of home fixtures 500. The user may select a color swatch to view an image of the home fixture 500 overlaid with a color of the color swatch. Where the selected home fixture 500 has been saved to a list, whichever color the user may have selected in the specifications screen may also be saved to the list.

A selecting of the accessories button 210 results in the generation of a screen with a variety of accessories such as faucets, handles, knobs, etc. that may be used with the home fixtures 500. For example, a pop-out panel may be loaded with information about all available accessories for the home fixture 500 selected. Any accessory image available in the pop-out panel may be selected by the user to view an overlay of that accessory on an image of the home fixture 500. Individual color images of the accessories with multiple colors may also be selected by the user to view a specific color accessory overlaid on the image of the home fixture 500.

A selecting of the high definition images button 212 results in the generation of a screen that permits the user to view high definitions photographs of the home fixtures 500. For example, a pop out menu may extend out and a list of available image thumbnails will appear for further selection. The thumbnail images can include alternative views, installed photographs, and available accessories, as nonlimiting examples. The user may select any of the thumbnails to view an enlarged, high resolution version of the selected image in a pop up window. The user may select an exit button located adjacent the image to close the pop up window.

A selecting of the 360° view button 214 results in the generation of a screen that permits the user to view the home fixtures 500 from any vantage point. For example, a pop-out panel may extend out and a 360° navigation image will appear of the selected home fixture 500. To interact with the 360° navigator, the user may press and hold a finger over the image on the display 18, and drag the finger to the left or right side of the screen. The navigator on the screen will rotate the image of the selected home fixture 500 to the direction the user moves the finger. Other means for rotating the image of the selected home fixture 500 may also be used, as desired.

A selecting of the counter tops button 216 results in a generation of a screen that permits the user to choose different counter tops to use as the context 502 within which to view the home fixtures 500. For example, a pop-out panel may extend from a top of the screen. The pop-out panel includes an ability to overlay the most common granite and solid-surface counter tops over the selected home fixture 500.

The panel also gives the user an ability to photograph a custom piece of counter top through the use of the built-in camera 26 of the system 10. For example, as further described herein below, the user may select a custom button on the counter tops screen. The screen may then dim, and a view window may appear. The custom piece is aligned in front of the camera 26 so that the image of the custom piece completely fills the view window. The user may then tap another button to cause the camera 26 to take the photograph of the custom piece. After photographing the custom piece, the screen will return and show the selected home fixture 500 overlaid with the image of the custom piece.

A selecting of the save-to-list button 218 results in a generation of a screen that permits the user to save the results of the user's searching, and additionally to print or email the saved search results to the user's email address. For example, after selecting the home fixture 500, the user may save the home fixture 500 to a saved list. The user may later return to the selected home fixture 500 by opening the saved list, and selected the home fixture 500 saved to the saved list. The user may also edit the saved list, whereby the user is allowed to select individual ones of the home fixtures 500 saved to the saved list, or remove individual ones of the home fixtures 500 from the saved list.

The user may also adjust the settings of the system 10, as desired. For example, the user can select to have prices shown next to every one of the home fixtures 500. As another example, the user may also limit the home fixtures 500, accessories, and counter tops that may be used as contexts 502, to those available from specific suppliers. Other settings may also be modified by the user within the scope of the disclosure.

It should be understood that the particular searching and selecting of desired ones of the home fixtures 500 may be performed by way of the user touching the touch screen display 18 in each of the screens generated by the processor 12 after the user selects one of the navigation buttons. A virtual keyboard may also be provided for searching particular products by keywords. Additional descriptions, photo examples, and features of the system 10 and kiosk 200 may also be provided within the scope of the disclosure.

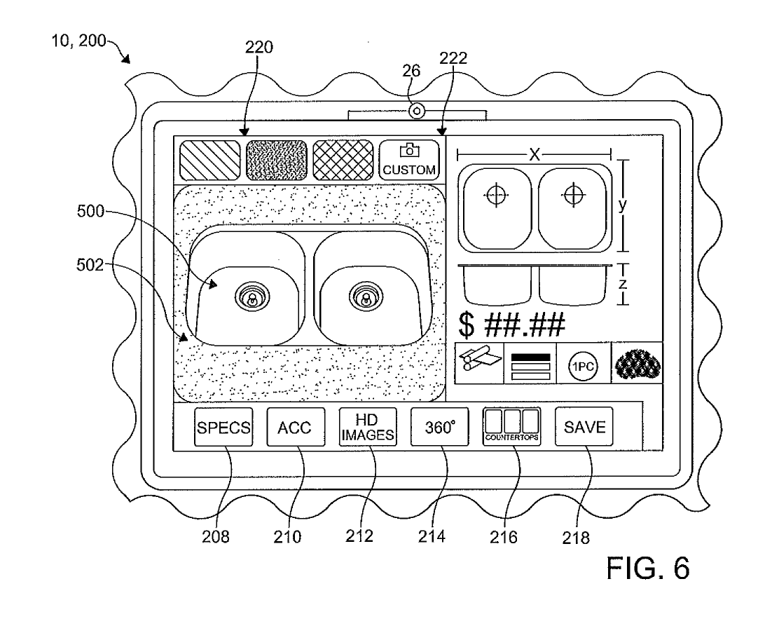

In a particular example, the screen 206 shown in FIG. 4 is provided by the user selecting the counter tops button 216. The screen 206 shows the selected on of the home fixtures 500, initially without the context 502 and other information corresponding to the home fixture 500 such as the specifications and the cost. The screen 206 also shows a listing of counter top options 220, each of which the user may touch in order to select and view the selected home fixture 500 in the context of the selected counter top, for example, as shown in FIG. 6.

The screen 206 also shows a custom counter top button 222. The user may touch the custom counter top button 222 in order to take the image of the surface 504 of the sample counter top, for example, the sample of granite counter top. After touching the custom counter top button 222, the user may hold the surface 504 in front of the camera 26 for acquisition of the image of the surface 504. The information corresponding to the image of the surface 504 is then stored in the memory 14 of the system 10 as the customized context 502. The system 10 then combines the selected home fixture 500 with the selected customized context 502 for viewing by the user, for example, as shown in FIG. 6. In this manner, the system 10 and method of the disclosure advantageously allows the user to view selected ones of the home fixtures 500 in the selected context 502 that may be associated with the user's desired location, such as a kitchen, for the home fixtures 500.

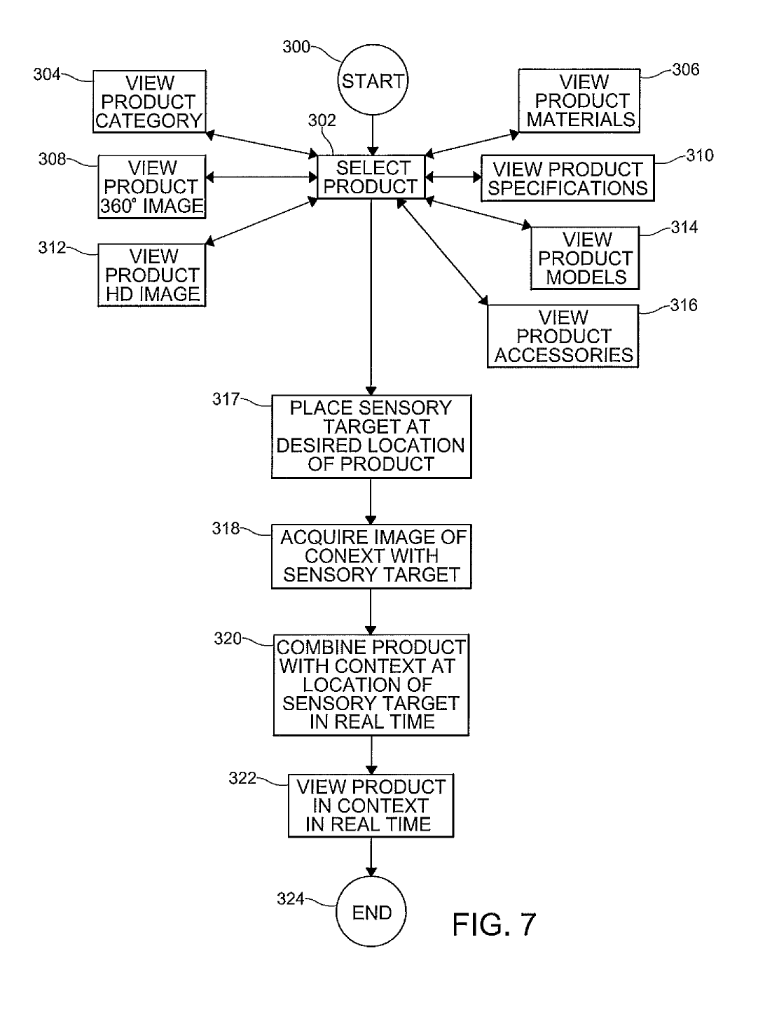

A method of using the system 10 according to another embodiment of the disclosure is shown as a flow diagram in FIG. 7. As with the earlier-described method, the method shown in FIG. 7 can be implemented as a software program residing in the memory 14 and executed based on inputs from the user utilizing the processor 12 of the system 10. The sequence of steps of the method will be described and then exemplary screens generated during the execution of the method steps will be described in more detail.

The method shown in FIG. 7 begins at a circle 300, in which the user is permitted to start a sequence of screens generated on the display 18 for the step 302 of selecting one of the plurality of home fixtures 500. The processor 12 generates the sequence of screens on the display 18. The screens on the display 18 may prompt the user provide inputs as instructions utilizing the input device 16. The inputs are utilized by the processor 12 to select the desirable home fixture 500. For example, the sequence of screens may include a product category screen 304, a product materials screen 306, a product 360° image screen 308, a product specifications screen 310, a product high definition image screen 312, a product models screen 314, and a product accessories screen 316. The user may navigate to one or more of these screens and select features therefrom using the input device 16, for the purpose of selecting the one of the plurality of home fixtures 500 in the step 302.

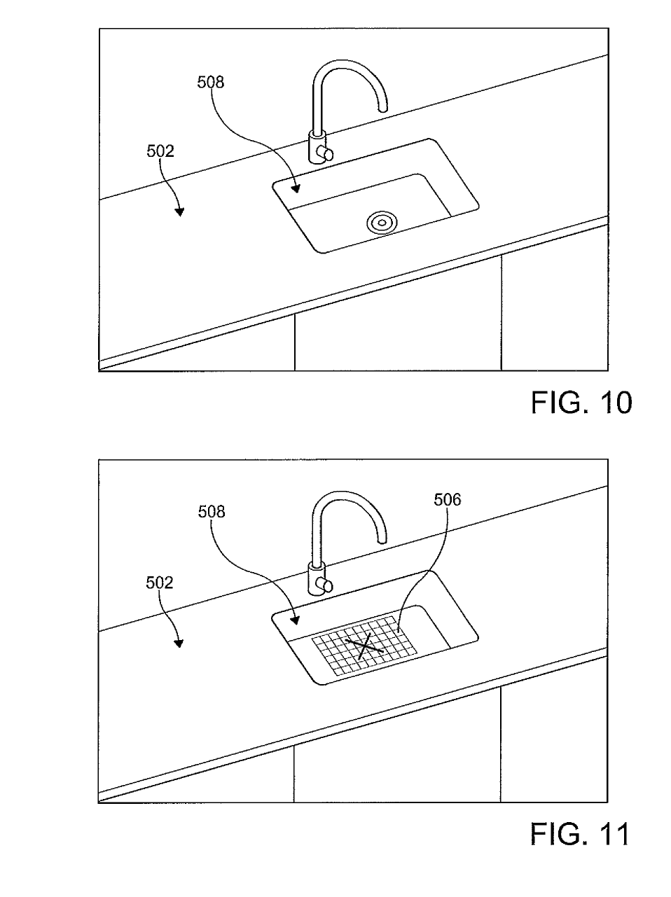

Following the step 302 of selecting the home fixture 500, the method includes a step 317 of placing a sensory target 506 at a location within the context 502. The location is selected by the user to be the location where the user would like the home fixture 500 to be disposed. In the particular embodiment shown in FIGS. 10 and 11, the sensory target 506 is placed at a kitchen on a pre-existing home fixture 508 such as a sink. As a nonlimiting example, the sensory target 506 may be provided as a sheet of paper with predetermined markings printed thereon on a conventional printer. Other types of sensory targets 506 may also be used within the scope of the disclosure.

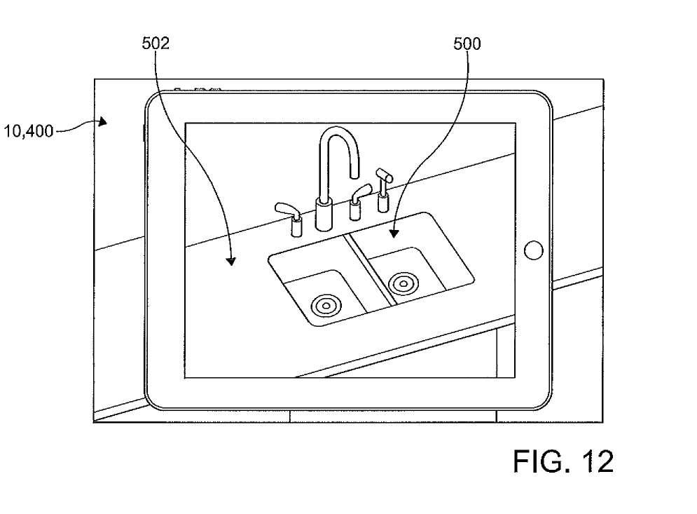

With renewed reference to FIG. 7, where the sensory target 506 has been placed at the desired location, the method includes a step 318 of acquiring with the camera 32 information corresponding to the sensory target 506 within the location. In real-time, and as depicted in FIG. 12, the information corresponding to the sensory target 506 is replaced with the information corresponding to the selected home fixture 500 on the screen of the display 18 in a step 320. Being real-time, the steps 318 and 320 may be repeated in order that the user may change the vantage point from which the location is being viewed in a subsequent step 322.

In the step 322, the appearance of the screen generated by the processor 12 may be updated nearly simultaneously with the user's change in vantage point, in order to provide the real-time view of the selected home fixture 500 in the location from any angle. Following the viewing of the screen generated by the processor 12, the method ends, as shown in circle 324. At the end of the method, the user is permitted to at least one of save the selected home fixture 500 to a list having information corresponding to at least one of the home fixtures 500, make a purchase of the selected home fixture 500, and repeat the method with a different home fixture 500. The user may also be permitted to save an image or a video generated by the processor 12, which shows the selected home fixture 500 in the context 502 of the user's location, and replacing the pre-existing home fixture 508.

In an illustrative embodiment shown in FIGS. 8-12, the system 10 is provided as a handheld mobile device 400 for selection of the home fixtures 500. The handheld mobile device 400 may be a smart phone or a tablet computer, as nonlimiting examples. Advantageously, the handheld mobile device 400 may be carried by the user to the location where the user desires to place the selected one of the home fixtures 500, for operation according to the method depicted in FIG. 7.

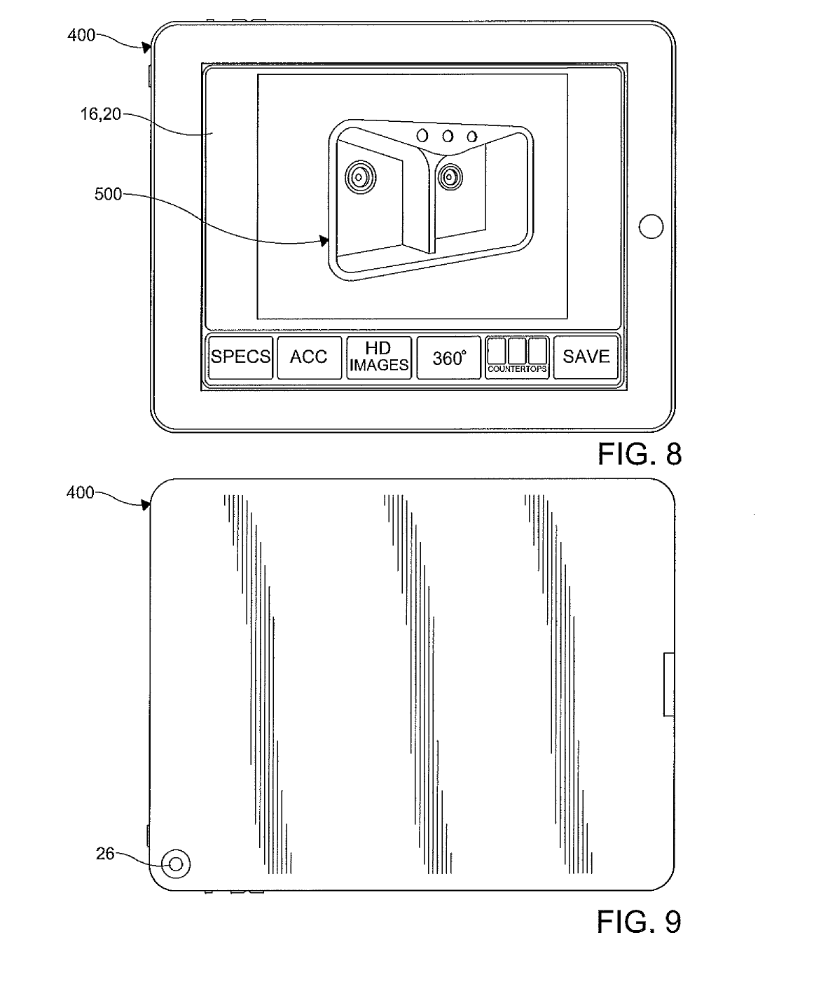

As illustrated in FIGS. 8 and 9, the handheld mobile device includes the graphical user interface 20 having the touch screen display 18. Advantageously, the handheld mobile device 400 also has the camera 26. Like the system 10 provided in the kiosk 200, the a variety of screens may be generated on the display 18 handheld mobile device 400 that permit the user to select the home fixture 500, as desired.

A particular embodiment in which the handheld mobile device 400 may be used is shown in FIGS. 10-12. In FIG. 10 a household location such as a kitchen with a pre-existing home fixture 508 such as a sink and faucet are shown. The user places the sensory target 506 within the sink, as illustrated in FIG. 11. The user then views the household location through the handheld mobile device 400, which in real-time replaces the pre-existing home fixture 508 with the selected home fixture 500, in accordance with the previously-described method.

Advantageously, the system 10 and methods of using the same provides the user with a full catalog listing of products, including detailed specifications, overlays of accessories on products, 360° views of very product, high resolution photos of every product and accessory, and options to save any product to a list for later review. The user can also edit and email a list of products to the user's email account with full specifications. Importantly, the system 10 and methods permit the user to apply a popular counter top behind the product as contents, as well as to acquire customized photographs for providing the context within which the product is viewed. It is also particularly advantageous that the system 10 permits the user to view the product using “augmented reality” in the user's home.

While certain representative embodiments and details have been shown for purposes of illustrating the invention, it will be apparent to those skilled in the art that various changes may be made without departing from the scope of the disclosure, which is further described in the following appended claims.

What is claimed is:

1. A system for selecting one of a plurality of home fixtures, comprising:
a processor for executing instructions to present information corresponding to the home fixtures;
a memory in communication with the processor, the memory including at least one database with the information corresponding to the home fixtures, the database also including information corresponding to a context that may be associated with the home fixtures;
an input device in communication with the processor, the input device permitting a user to select the one of the home fixtures to be presented; and
a display in communication with the processor, the display configured for showing the information corresponding to the home fixtures.

2. The system of claim 1, wherein the information corresponding to the home fixtures includes at least one of materials, models, categories, accessories, 360° views, high definition images, and specifications.

3. The system of claim 1, wherein the information corresponding to the context includes a plurality of different surfaces in which the home fixture may be disposed.

4. The system of claim 1, further comprising a camera in communication with the processor for acquiring additional information corresponding to the context.

5. The system of claim 4, wherein the additional information corresponding to the context includes an image of a surface in which the home fixture may be disposed.

6. The system of claim 4, where the additional information corresponding to the context includes an image of a location in which the home fixture may be disposed.

7. The system of claim 1, wherein the input device and the display are provided together as a graphical user interface.

8. The system of claim 7, wherein the graphical user interface is a touch screen display.

9. The system of claim 4, wherein the processor, the memory, the input device, the display, and the camera are included in a stand alone kiosk.

10. The system of claim 4, wherein the processor, the memory, the input device, the display, and the camera are included in a handheld mobile device.

11. The system of claim 1, wherein the memory is in communication with a server via a network connection, the server permitted to update the information corresponding to the home fixtures in the database on the memory.

12. The system of claim 1, wherein the plurality of home fixtures include a plurality of sinks.

13. A method for selecting one of a plurality of home fixtures, the method comprising the steps of:
storing in a database of a memory information corresponding to home fixtures and information corresponding to a context that may be associated with the home fixtures;
generating a screen on a display for showing the information corresponding to the home fixtures and the information corresponding to the context that may be associated with the home fixtures;
selecting the one of the plurality of home fixtures based upon inputs provided by the user through an input device; and
showing on the screen the information corresponding to the selected home fixture.

14. The method of claim 13, further comprising the steps of:
selecting the context that may be associated with the home fixtures based upon inputs provided by the user through the input device;
associating the information corresponding to the selected context with the information corresponding to the selected home fixture; and
showing on the screen the information corresponding to the selected home fixture and the information corresponding to the selected context, whereby the selected home fixture may be viewed by the user in the selected context.

15. The method of claim 14, further comprising the step of acquiring additional information corresponding to the context that may be associated with the home fixtures from a camera.

16. The method of claim 15, wherein the selected context is based on the acquired additional information from the camera.

17. A method for selecting one of a plurality of home fixtures, the method comprising the steps of:
storing in a database of a memory information corresponding to home fixtures and information corresponding to a context that may be associated with the home fixtures;
generating a screen on a display for showing the information corresponding to the home fixtures and the information corresponding to the context that may be associated with the home fixtures;
selecting the one of the plurality of home fixtures based upon inputs provided by the user through an input device;
acquiring with a camera the information corresponding to the context that may be associated with the home fixtures;
associating the selected context with the selected home fixtures; and
in real-time, showing on the screen of the display the information corresponding to the selected home fixture and the information corresponding to the context, whereby the selected home fixture may be viewed by the user in the selected context.

18. The method of claim 17, further comprising the steps of:
placing a sensory target at a location within the context;
acquiring with the camera information corresponding to the sensory target; and
replacing the information corresponding to the sensory target with the information corresponding to the selected home fixture on the screen of the display.

19. The method of claim 18, wherein the location for the sensory target is a pre-existing home fixture within the context, whereby the selected home fixture may be viewed by the user on the screen of the display instead of the pre-existing home fixture.

20. The method of claim 19, wherein the sensory target is printed on paper, the location for the sensory target is a kitchen, the context is a counter top surface, and the pre-existing home fixture and the selected home fixture are both sinks, whereby the user may view through the screen of the display the selected home fixture as if present in the counter top in real-time.
